(19) United States
(12) Patent Application Publication
(10) Pub. No.: US 2013/0247332 A1
(43) Pub. Date: Sep. 26, 2013

(54) HEALING WAND EXTENSION DEVICE

(71) Applicant: Richard Dean Villanueva Sr., San Bernardino, CA (US)

(72) Inventor: Richard Dean Villanueva Sr., San Bernardino, CA (US)

(21) Appl. No.: 13/424,268

(22) Filed: Mar. 20, 2012

(51) Int. Cl. B25G 1/10

(52) U.S. Cl. 16/430

(57) ABSTRACT

A healing wand extension device comprised of a stick with a hand grip portion at a proximal end and an opening at a distal end is shown and described. The opening contains an “o” ring capable of supporting a wand healing device such as the Amega Amwand, and therefore has a circumference sufficiently wide to support said device. The o-ring should be made of rubber, silicone, neoprene or other elastic material with a non-slippery surface so that a wand healing device can be inserted through the o-ring without easily slipping out. While the structure can vary, a rectangular structure with curved corners or an oval structure is preferred in order to avoid unintentional scratching or chafing while in use. A curvy side profile is preferred to assist with applying mild to moderate pressure in hard-to-reach areas.

### CROSS-REFERENCE TO RELATED APPLICATION

This application claims priority to provisional patent application No. 61/464,280 filed on Mar. 17, 2012.

### FEDERALLY SPONSORED RESEARCH

Not Applicable

### SEQUENCE LISTING OR PROGRAM

Not Applicable

### STATEMENT REGARDING COPYRIGHTED MATERIAL

Portions of the disclosure of this patent document contain material that is subject to copyright protection. The copyright owner has no objection to the facsimile reproduction by anyone of the patent document or the patent disclosure as it appears in the Patent and Trademark Office file or records, but otherwise reserves all copyright rights whatsoever.

### BACKGROUND

The invention relates to an extension device that attaches to a healing wand in order to extend its reach.

Healing wands are devices that are said to promote self-healing when a user places the healing wand around an area of their body. One of such devices is called an Amega Amwand which is said to contain a mixture of granulated minerals and created by a technology called AMized® fusion. According to its makers, the device has a resonance that activates the life force energy inside cells and tissues, unblocks energy channels and promotes self-healing and well-being.

Healing wand such as the Amega Amwand are made to resemble pens for the purpose of convenience. However, this also means that their short length makes it difficult for a user to apply a healing wand to hard-to-reach areas of the body, such as the back and the extremities.

The objective of the present invention is to extend the reach of a healing wand by attaching the healing wand to an extension device, which a user can use like a back scratcher. The inventive extension device is in the form of a stick, preferably with a curved back and arched head, the head comprising a hole supported by an o-ring whose made with material sufficient to grasp a metallic healing wand, and with a circumference sufficiently wide to insert a healing wand.

### SUMMARY

The invention is a healing wand extension device comprised of a stick with a hand grip portion at a proximal end and an opening at a distal end. The opening contains an “o” ring capable of supporting a wand healing device such as the Amega Amwand, and therefore has a circumference sufficiently wide to support said device. The o-ring should be made of rubber, silicone, neoprene or other elastic material with a non-slippery surface so that a wand healing device can be inserted through the o-ring without easily slipping out. While the structure can vary, a rectangular structure with curved corners or an oval structure is preferred in order to avoid unintentional scratching or chafing while in use. A curvy side profile is preferred to assist with applying mild to moderate pressure in hard-to-reach areas.

### FIGURES

FIG. 1 is a top view of a healing wand extension device with a rectangular structure

FIG. 2 is a top view of another example of a healing wand extension device with a rectangular structure and curved corners

FIG. 3 is a top view of another example of a healing wand extension device with a long oval structure (features not shown)

FIG. 4 is a side cross section view of the healing wand extension device illustrating an opening at a distal end.

FIG. 5 is a side view of the preferred embodiment of the healing wand extension device with a wavy structure

### DETAILED DESCRIPTION

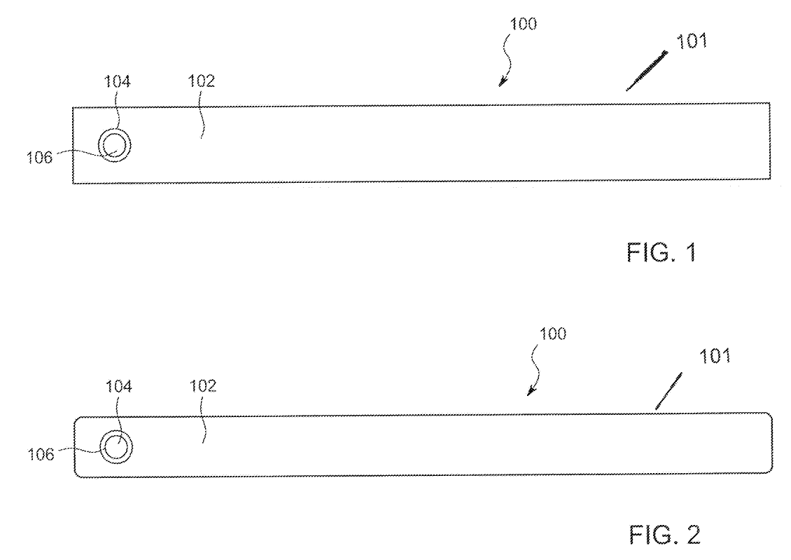

FIG. 1 shows an example of a top view of a healing wand extension device 100 with a rectangular structure comprised of a stick 102 with a hand grip portion 101 at a proximal end and an opening 106 at a distal end. The opening contains an “o” ring 104 capable of supporting a wand healing device 100 such as the Amega Amwand, and therefore has a circumference sufficiently wide to support said device. The o-ring 104 should be made of rubber, silicone, neoprene or other elastic material with a non-slippery surface so that a wand healing device 100 can be inserted through the o-ring 104 without easily slipping out.

FIG. 2 shows the same features as FIG. 1 but with curved corners to avoid unwanted scratches to the back when utilizing the healing wand extension device 100.

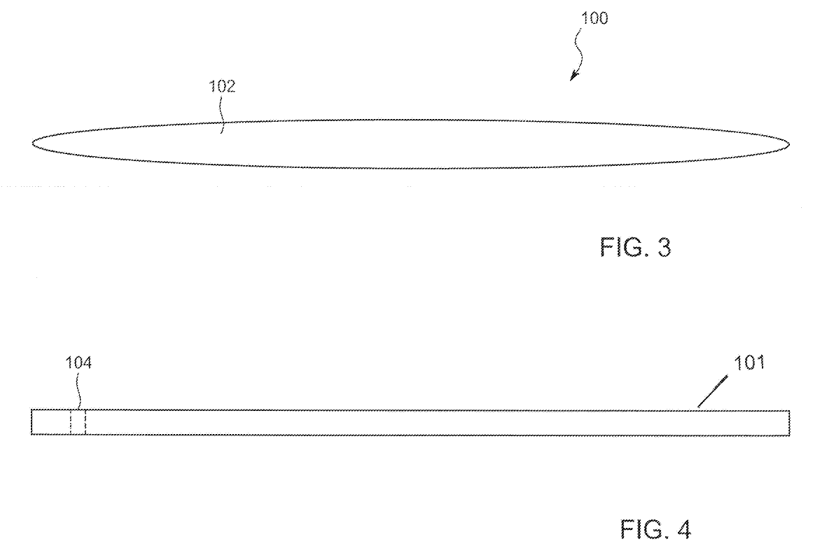

FIG. 3 shows another embodiment of the healing wand extension device 100 in the form of an oval, which greatly reduces the risk of unwanted scratching or chafing when the healing wand extension device 100 is in use.

FIG. 4 is a side cross-sectional view of the healing wand extension device 100 showing the opening 106 at the distal end.

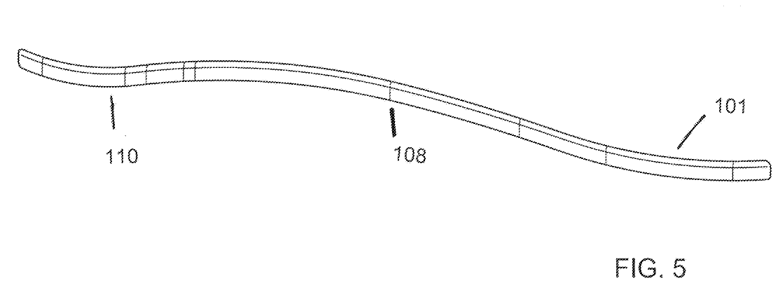

FIG. 5 shows the preferred embodiment of the healing wand extension device 100 shown with a wavy side profile, in particular, a curved back 108 and an arched head 110. The embodiment operates similar to a toothbrush in that it helps the user to apply pressure to hard-to-reach areas.

The healing wand extension device 100 can be made of wood, plastic, metal or other hard substance that would not easily break when applying gentle to moderate pressure to the back. The preferred embodiment for the dimensions of the healing wand extension device 100 is ¾ inch thick by 1 inch wide by 12 inches long. Thickness can vary to ½ inch, ⅜ inch, ⅝ inch, by way of example. Width can vary to ½ inch, ¾ inch, and 1 inch, by way of example. Length can vary to 6 inch, 12 inch, 18 inch, and 24 inch, by way of example.

All features disclosed in this specification, including any accompanying claims, abstract, and drawings, may be replaced by alternative features serving the same, equivalent or similar purpose, unless expressly stated otherwise. Thus, unless expressly stated otherwise, each feature disclosed is one example only of a generic series of equivalent or similar features.

Although preferred embodiments of the present invention have been shown and described, various modifications and substitutions may be made thereto without departing from the spirit and scope of the invention. Accordingly, it is to be understood that the present invention has been described by way of illustration and not limitation.

What is claimed is:

1. A healing wand extension device comprised of a stick with a hand grip portion at a proximal end and an opening at a distal end, and an o-ring disposed within the opening having an inner circumference sufficiently wide to allow for the insertion of a healing wand and composed of a non-slip, elastic material.

2. The healing wand extension device of claim 1, wherein the stick is rectangular with curved edges.

3. The healing wand extension device of claim 1, wherein the stick has an elongated oval shape.

4. The healing wand extension device of claim 1, wherein the stick has a wavy side profile, including, a curve back and an arched head.

5. The healing wand device of claim 1, wherein the o-ring is composed of rubber, silicone, or neoprene.

6. The healing wand device of claim 1, wherein the stick is composed of wood, plastic, or metal.
